(19) United States
(12) Patent Application Publication
(10) Pub. No.: US 2025/0379659 A1
(43) Pub. Date: Dec. 11, 2025

(54) SAMPLE INTERVAL SYNCHRONOUS POSITION NOTIFICATION DEVICE, OPTICAL RECEIVER AND SAMPLE INTERVAL SYNCHRONOUS POSITION NOTIFICATION METHOD

(71) Applicant: NIPPON TELEGRAPH AND TELEPHONE CORPORATION, Tokyo (JP)

(72) Inventors: Masanori NAKAMURA, Musashino-shi (JP); Etsushi YAMAZAKI, Musashino-shi (JP); Mitsuteru YOSHIDA, Musashino-shi (JP); Yoshiaki KISAKA, Musashino-shi (JP)

(73) Assignee: NIPPON TELEGRAPH AND TELEPHONE CORPORATION, Tokyo (JP)

(21) Appl. No.: 18/876,337

(22) PCT Filed: Jul. 13, 2022
(86) PCT No.: PCT/JP2022/027601

§ 371 Date: Dec. 18, 2024

(51) Int. Cl. H04B 10/61; H04L 25/03

(52) U.S. Cl. CPC H04B 10/6165; H04L 25/03057

(57) ABSTRACT

A sample interval synchronized position notification device includes: a tap coefficient acquisition unit configured to acquire a tap coefficient from an adaptive equalization unit which is configured to perform adaptive equalization of a signal; a group delay calculation unit configured to calculate a group delay based on the tap coefficient; and a shift amount calculation unit configured to calculate a shift amount based on the group delay.

### TECHNICAL FIELD

The present invention relates to a sample interval synchronized position notification device (a sample interval synchronous position notification device), an optical receiver, and a sample interval synchronized position notification method (a sample interval synchronous position notification method).

### BACKGROUND ART

Digital coherent transmission enables synchronization of transmission and reception frames by digital signal processing of the received signal, compensation for waveform distortion occurring in an optical fiber transmission line, and adaptive compensation for device imperfections in optical transceivers. In the method described in PTL 1, frames are synchronized by synchronizing symbol intervals within transmission and reception frames. Furthermore, NPL 1 discloses a method of synchronizing sampling phases.

### CITATION LIST

### Patent Literature

PTL 1: Japanese Patent No. 6126404

### Non Patent Literature

NPL 1: F. M. Gardner, “Interpolation in digital modems. I. Fundamentals,” in IEEE Transactions on Communications, vol. 41, No. 3, pp. 501-507, March 1993

NPL 2: Md. Saifuddin Faruk and Seb J. Savory, “Digital Signal Processing for Coherent Transceivers Employing Multilevel Formats,” J. Lightwave Technol. 35, 1125-1141 (2017)

### SUMMARY OF INVENTION

### Technical Problem

However, in the methods disclosed in PTL 1 and NPL 1, it is not possible to control symbol points and transition points between symbols in transmission and reception frames. Therefore, under conditions where a pulse spread becomes large due to polarization mode dispersion, a pulse may not fit within a tap range of the adaptive equalization circuit, and signal quality may deteriorate depending on the synchronized position at the time of initial pull-in.

### Solution to Problem

One aspect of the present invention is a sample interval synchronized position notification device, including: a tap coefficient acquisition unit configured to acquire a tap coefficient from an adaptive equalization unit which is configured to perform adaptive equalization of a signal; a group delay calculation unit configured to calculate a group delay based on the tap coefficient; and a shift amount calculation unit configured to calculate a shift amount based on the group delay.

Another aspect of the present invention is a sample interval synchronized position notification method, including: a tap coefficient acquisition step of acquiring a tap coefficient from an adaptive equalization unit; a group delay calculation step of calculating a group delay based on the tap coefficient; and a shift amount calculation step of calculating a shift amount based on the group delay.

### Advantageous Effects of Invention

The present invention provides a sample interval synchronized position notification device, an optical receiver, and a sample interval synchronized position notification method, each of which is capable of calculating a group delay for controlling a synchronized position at the time of initial pull-in to be an appropriate position.

### BRIEF DESCRIPTION OF DRAWINGS

FIG. 1 is a diagram illustrating a configuration example of an optical receiver 1.

FIG. 2 is a diagram illustrating a configuration example of a sampling phase synchronization unit 14.

FIG. 3 is a diagram illustrating a configuration example of an adaptive equalization unit 15.

FIG. 4 is a flowchart showing operations of the optical receiver 1.

FIG. 5 is a diagram illustrating a configuration example of a sample interval synchronized position notification device 18.

FIG. 6 is a flowchart illustrating operations of the sample interval synchronized position notification device 18.

FIG. 7 is a flowchart illustrating a method for calculating a group delay.

FIG. 8 is a flowchart illustrating a method for calculating a group delay.

FIG. 9 is a flowchart illustrating a method for calculating a group delay.

### DESCRIPTION OF EMBODIMENTS

### Overall Configuration

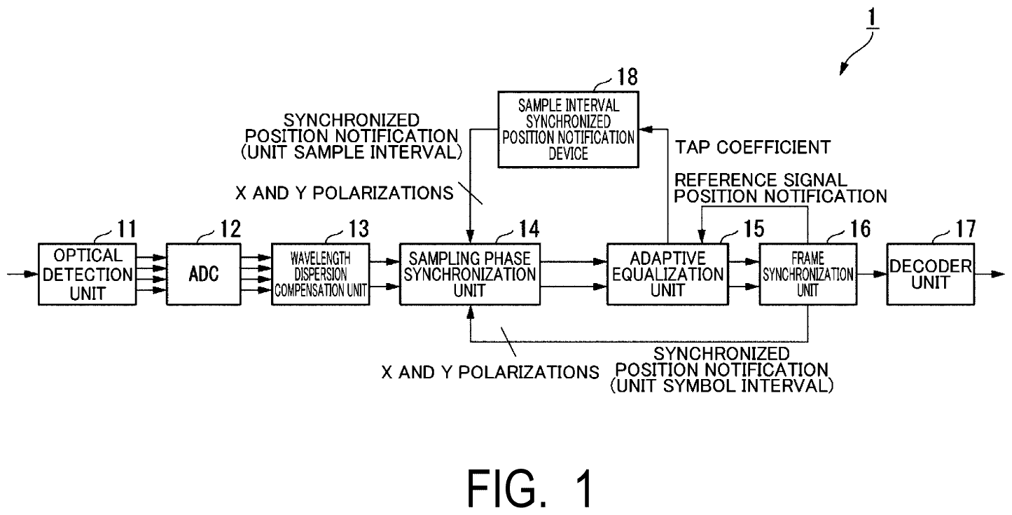

FIG. 1 is a diagram illustrating a configuration example of an optical receiver 1. The optical receiver 1 includes an optical detection unit 11, an ADC 12, a wavelength dispersion compensation unit 13, a sampling phase synchronization unit 14, an adaptive equalization unit 15, a frame synchronization unit 16, a decoder unit 17, and a sample interval synchronized position notification device 18.

The optical detection unit 11 converts a received polarization-multiplexed optical signal into an electrical signal. The optical detection unit 11 converts the received optical signal into four systems of electrical signals, XI, XQ, YI, and YQ, for example, by coherent detection or square-law detection that interferes with local light. The received optical signal is, for example, modulated at a carrier frequency. Electrical signals occupy a baseband frequency band.

The ADC 12 converts the four electrical signals XI, XQ, YI, and YQ output from the optical detection unit 11 from analog signals to digital signals. The ADC 12 oversamples the analog signals. For example, in a case where the ADC 12 samples at a sampling frequency twice a symbol rate (modulation rate) (two-oversampling), if a sampling phase is synchronized, a point (sample point) detected as a digital signal in an analog signal is divided into a signal (symbol point) detected when sampling at the sampling frequency and a point (transition point) detected between adjacent symbol points. For digital signals whose sampling phases are not synchronized, symbol points and transition points cannot be distinguished.

The wavelength dispersion compensation unit 13 converts the digital signal output from the ADC 12 from a real number signal to a complex number signal such that an X polarization signal is converted into X=XI+jXQ and a Y polarization signal is converted into Y=YI+jYQ, followed by wavelength dispersion compensation. j represents the imaginary unit.

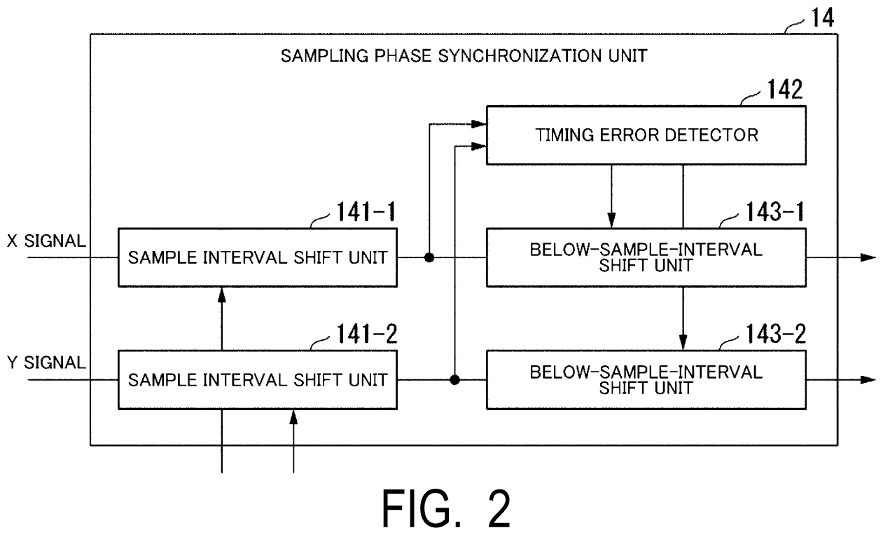

The sampling phase synchronization unit 14 synchronizes sampling phases of the X and Y signals. FIG. 2 is a diagram illustrating a configuration example of the sampling phase synchronization unit 14. The sampling phase synchronization unit 14 is provided with sample interval shift units 141-1 and 141-2, a timing error detector 142, and below-sample-interval shift units 143-1 and 143-2.

The sample interval shift units 141-1 and 141-2 shift phases between the X and Y signals, respectively. The timing error detector 142 detects sampling timings of the X and Y signals output from the sample interval shift units 141-1 and 141-2. The timing error detector 142 is, for example, a Gardner detector. The below-sample-interval shift units 143-1 and 143-2 shift sample positions of the X and Y signals at a cycle below a sampling cycle based on the sampling timing detected by the timing error detector 142 and a synchronized position detected by the frame synchronization unit 16 described below. The below-sample-interval shift units 143-1 and 143-2 can synchronize the timing of sample points by shifting with a cycle below the sampling cycle, but cannot distinguish whether a particular sample point is a symbol point or a transition point.

The sample interval shift units 141-1 and 141-2 shift a phase based on a shift amount input from the sample interval synchronized position notification device 18 (described later) and synchronized position information in interval units at a symbol point input from the frame synchronization unit 16 (described later). Thereby, the sample interval shift units 141-1 and 141-2 can distinguish whether a specific sample point is a symbol point or a transition point, and then enable synchronization. The specific operations of the sample interval shift units 141-1 and 141-2 will be described later.

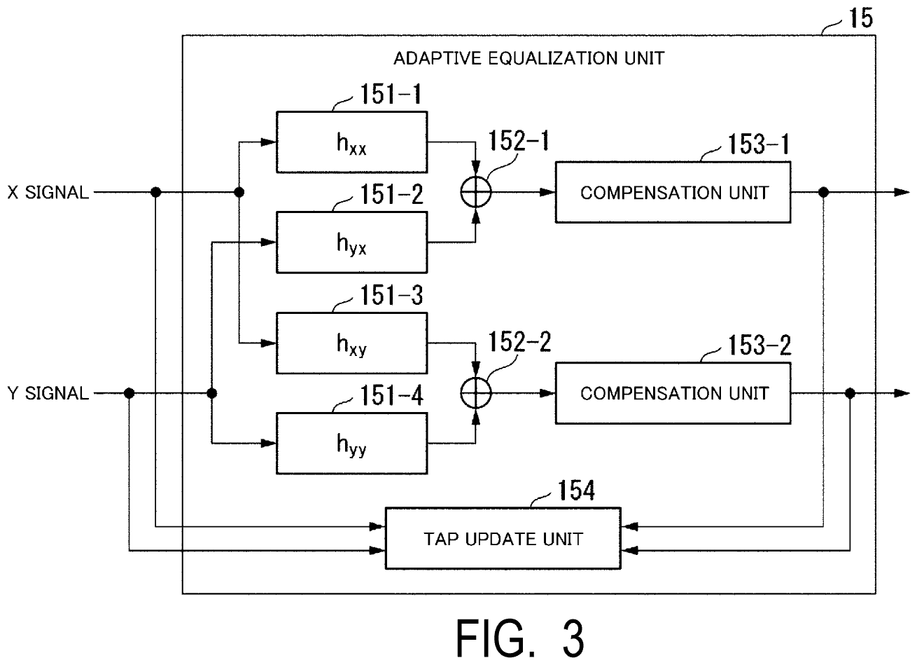

The adaptive equalization unit 15 adaptively equalizes the optical signal input by the sampling phase synchronization unit 14 and compensates for distortion generated in the waveform. FIG. 3 is a diagram illustrating a configuration example of the adaptive equalization unit 15. The adaptive equalization unit 15 includes filters 151-1, 151-2, 151-3 and 151-4, multiplexers 152-1 and 152-2, compensation units 153-1 and 153-2, and a tap update unit 154. The filters 151 are FIR filters (finite impulse response filter) and filter the signal according to a tap coefficient. The filter 151-1 filters the X signal according to a tap coefficient hₓₓ, the filter 151-2 filters the Y signal according to a tap coefficient h_{yx}, the filter 151-3 filters the X signal according to a tap coefficient h_{xy}, and the filter 151-4 filters the Y signal according to a tap coefficient h_{yy}. Thereby, the filter 151 equalizes a time spread of the impulse response due to polarization fluctuations and polarization mode dispersion. For the filter 151-1, a tap coefficient of the n-th filter is expressed as hₓₓ(n), and for the respective filters 151-2 to 151-4, the tap coefficient is represented similarly.

The filters 151 downsample an oversampled digital signal to a symbol rate, and output a digital signal at the symbol rate (interval unit of symbol point). For example, in a case where a two-oversampled signal is input to the filter 151, this is achieved by not outputting the output of the FIR filter once every two times.

The multiplexer 152-1 multiplexes signals filtered by the filters 151-1 and 151-2. The multiplexer 152-2 multiplexes signals filtered by the filters 151-3 and 151-4.

The compensation unit 153-1 performs compensation for a signal multiplexed by the multiplexer 152-1. The compensation unit 153-2 performs compensation for a signal multiplexed by the multiplexer 152-2. The compensation units 153-1 and 153-2 compensate for frequency offset and phase noise of the signals. The tap update unit 154 updates tap coefficients of the filter 151. The tap update unit 154 updates the tap coefficients using, for example, the CMA algorithm or DD-LMS algorithm described in NPL 2. In the CMA algorithm and DD-LMS algorithm, a synchronized position of the signal output by the frame synchronization unit 16, which will be described later, is not required, but taps may be updated using a difference between a reference signal and the received symbol calculated from the synchronized position in the DD-LMS algorithm.

The frame synchronization unit 16 detects a synchronized position using a temporal shift amount between the reference signal output from the adaptive equalization unit 15 and the received signal as the number of symbols. The frame synchronization unit 16 outputs the synchronized position to the sampling phase synchronization unit 14. The synchronized position of the signal detected by the frame synchronization unit 16 corresponds to a unit symbol point interval.

The decoder unit 17 decodes the signal output from the frame synchronization unit 16.

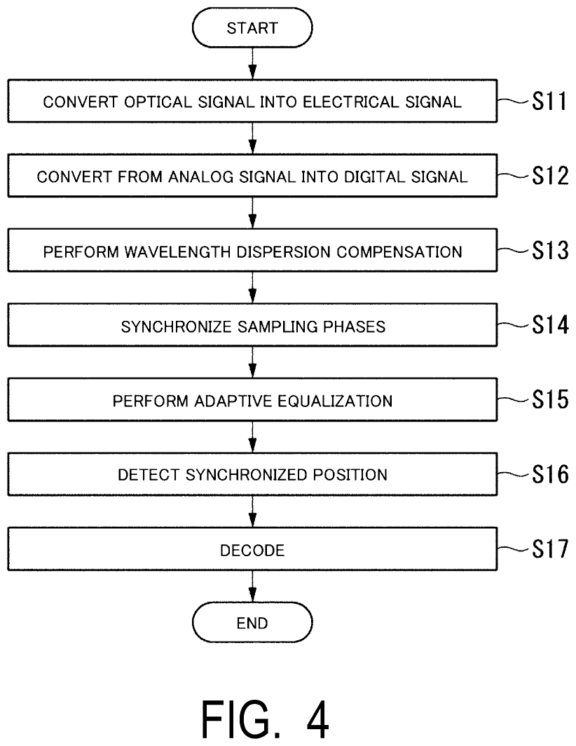

FIG. 4 is a flowchart showing operations of the optical receiver 1. The optical detection unit 11 converts the optical signal into an electrical signal (step S11). The ADC 12 converts the electrical signal, which is an analog signal, into a digital signal (step S12). The wavelength dispersion compensation unit 13 compensates for wavelength dispersion of the signal (step S13). The sampling phase synchronization unit 14 synchronizes sampling phases (step S14). The adaptive equalization unit 15 adaptively equalizes the signal (step S15). The frame synchronization unit 16 detects a synchronized position (step S16). The decoder unit 17 decodes the signal (step S17).

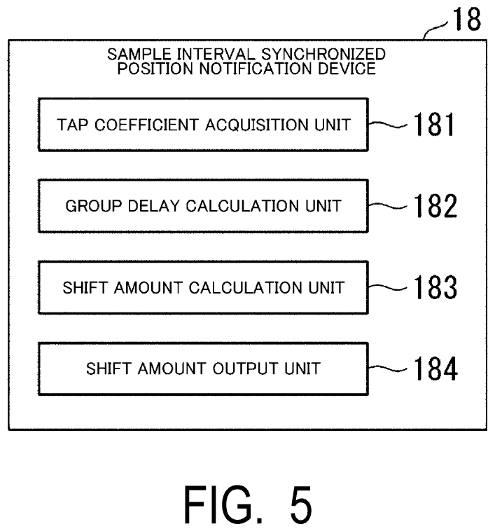

FIG. 5 is a diagram illustrating a configuration example of the sample interval synchronized position notification device 18. The sample interval synchronized position notification device 18 includes a tap coefficient acquisition unit 181, a group delay calculation unit 182, a shift amount calculation unit 183, and a shift amount output unit 184.

The tap coefficient acquisition unit 181 acquires tap coefficients from adaptive equalization unit 15. The group delay calculation unit 182 calculates group delay based on the tap coefficients.

### First Calculation Method

A method for calculating a group delay by the group delay calculation unit 182 will be described. The group delay calculation unit 182 first performs a discrete Fourier transform on the tap coefficients (hₓₓ, h_{yx}, h_{xy}, h_{yy}). For example, the group delay calculation unit 182 performs a discrete Fourier transform on the tap coefficient hₓₓ using Equation (1) to calculate Hₓₓ.

$$\begin{matrix}[ Math . 1 ] & \\ {H}_{xx} ( ω ) = {\sum }_{i = 0}^{N} {h}_{xx} ( i ) {e}^{- i ω t} & ( 1 )\end{matrix}$$

ω represents an angular frequency. The group delay calculation unit 182 performs a discrete Fourier transform on the tap coefficients h_{yx}, h_{xy}, and h_{yy} in the same manner as hₓₓ, and calculates H_{yx}, H_{xy}, and H_{yy}. For example, Hₓₓ, H_{yx}, H_{xy}, and H_{yy} Can be represented as a matrix in Equation (2).

$$\begin{matrix}[ Math . 2 ] & \\ H ( ω ) = [ \begin{matrix}{H}_{xx} ( ω ) & {H}_{yx} ( ω ) \\ {H}_{xy} ( ω ) & {H}_{yy} ( ω )\end{matrix} ] & ( 2 )\end{matrix}$$

A transfer function H₀(ω) can be calculated using the determinant of the matrix shown in Equation (2).

$$\begin{matrix}[ Math . 3 ] & \\ {H}_{0} ( ω ) = \sqrt{{H}_{x x} ( ω ) {H}_{y y} ( ω ) - {H}_{y x} ( ω ) {H}_{x y} ( ω )} & ( 3 )\end{matrix}$$

Equation (2) can be rewritten as Equation (4).

$$\begin{matrix}[ Math . 4 ] & \\ [ \begin{matrix}{H}_{x x} ( ω ) & {H}_{y x} ( ω ) \\ {H}_{x y} ( ω ) & {H}_{y y} ( ω )\end{matrix} ] = {H}_{0} ( ω ) [ \begin{matrix}{U}_{x x} ( ω ) & {U}_{y x} ( ω ) \\ {U}_{x y} ( ω ) & {U}_{y y} ( ω )\end{matrix} ] & ( 4 )\end{matrix}$$

A matrix whose elements are Uₓₓ(ω), U_{yx}(ω), U_{xy}(ω), and U_{yy}(ω) is a unitary matrix representing the polarization state. That is, Uₓₓ(w)=U_{yy}*(ω), U_{yx}(ω)=−U_{xy}*(ω). * represents a complex conjugate. Therefore, due to the properties of discrete Fourier transform, Uₓₓ(t)=u_{yy}(−t), u_{yx}(t)=−u_{xy}(−t), and time spreads of impulse responses uₓₓ and u_{yy}, and u_{yx} and u_{xy} are spread symmetrically about t=0. uₓₓ(t), u_{yx}(t), u_{xy}(t), and u_{yy}(t) indicate impulse responses in the time domain after inverse discrete Fourier transform of Uₓₓ, U_{y}x, U_{xy}, and Uyy, respectively, in the time domain. Therefore, it can be understood that a compensation amount for polarization mode dispersion is maximum when the group delay τ(ω) of H0(ω) corresponds to a temporal center position τof the tap coefficients (hₓₓ, h_{yx}, h_{xy}, h_{yy}). τₒₚₜ is expressed by Equation (5).

$$\begin{matrix}[ Math . 5 ] & \\ {τ}_{o p t} = ⌊ \frac{K}{2} ⌋ \times {T}_{i n t} & ( 5 )\end{matrix}$$

K is a tap length (a natural number of 1 or more), and Tᵢₙₜ is the sample interval time. The right side of Equation (5) is the product of a floor function of K/2 and the sample interval time.

Equation (6) is established as follows:

$$\begin{matrix}[ Math . 6 ] & \\ {H}_{0}^{2} ( ω ) = \vert {H}_{0}^{2} ( ω ) \vert exp [ j 2 ϕ ( ω ) ] = {H}_{xx} ( ω ) {H}_{y y} ( ω ) - {H}_{y x} ( ω ) {H}_{x y} ( ω ) & ( 6 )\end{matrix}$$

In Equation (6), φ(ω)=arg[H₀(ω)], and arg(A) is an argument of A.

The group delay calculation unit 182 calculates group delay τ(ω) using Equation (7).

$$\begin{matrix}[ Math . 7 ] & \\ τ ( ω ) = - \frac{ϕ ( ω + δω ) - ϕ ( ω )}{δ ω} = - \frac{arg [ {H}_{0}^{2} ( ω + δ ω ) {H}_{0}^{{2}^{*}} ( ω ) ]}{2 δ ω} = - \frac{arg [ \{ {H}_{xx} ( ω + δ ω ) {H}_{y y} ( ω + δ ω ) - {H}_{y x} ( ω + δ ω ) {H}_{x y} ( ω + δ ω ) \} \{ {H}_{xx}^{*} ( ω ) {H}_{y y}^{*} ( ω ) - {H}_{y x}^{*} ( ω ) {H}_{x y}^{*} ( ω ) \} ]}{( 2 δω )} & ( 7 )\end{matrix}$$

In Equation (7), φ(ω) is a phase when the angular frequency is ω, and H₀*(ω) is a complex conjugate of H₀(ω).

The shift amount calculation unit 183 calculates a shift amount from the center of the tap of the adaptive equalization unit 15 based on the group delay τ(ω). The shift amount calculation unit 183 calculates a shift amount Δτ by averaging the group delay τ(ω) in the angular frequency range of the signal band and finding a difference from τₒₚₜ, for example. The shift amount calculation unit 183 calculates, for example, a plurality of group delays, plots them on a graph with the group delay on the vertical axis and the angular frequency on the horizontal axis, fits a plurality of points with a linear function, and calculates the difference between the intercept (that is, the group delay when the value of the angular frequency is 0) and τₒₚₜ, thereby calculating the shift amount Δτ.

The shift amount output unit 184 outputs the shift amount Δτ to the sampling phase synchronization unit 14 to notify the synchronization position in the unit sample interval. The sample interval shift units 141-1 and 141-2 add a value obtained by dividing the shift amount Δτ by the unit sample interval time (sample shift amount) to the set value. The sample interval shift units 141-1 and 141-2 may add a sample shift amount obtained by rounding off a number to a predetermined digit to the set value. After the set values of sample interval shift unit 141-1 and 141-2 are updated, the tap coefficients of the adaptive equalization unit are reconverged. At this time, since the time of the signal input to the FIR filter of the adaptive equalization unit is also shifted by the sample shift amount detected by the sample shift amount detection unit, it becomes possible to perform processing while maintaining the convergence state by shifting the tap coefficient in the opposite direction.

Further, the sampling phase synchronization unit 14 can also control the sample interval shift unit 141 and the below-sample-interval shift unit 143 based on the shift amount Δτ.

Specifically, regarding the value obtained by diving the shift amount Δτ by unit sample interval time, a rounded integer value is input to the sample interval shift unit 141 and a decimal value is input to the below-sample-interval shift unit 143. At this time, the timing error detector 142 can stop operating.

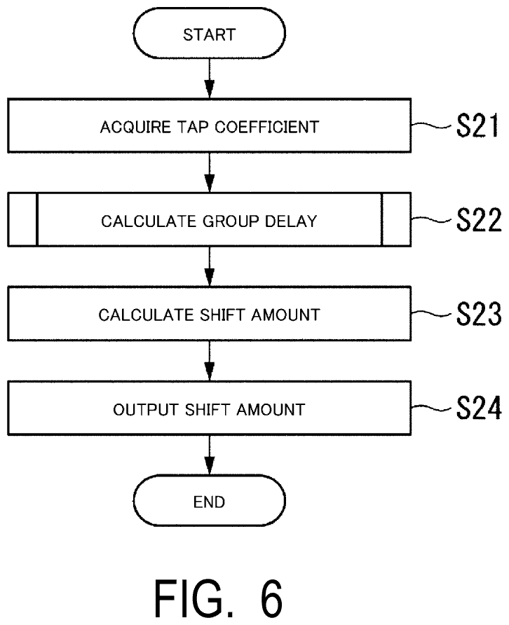

FIG. 6 is a flowchart illustrating operations of the sample interval synchronized position notification device 18. The tap coefficient acquisition unit 181 acquires the tap coefficient (step S21). The group delay calculation unit 182 calculates the group delay (step S22). The shift amount calculation unit 183 calculates the shift amount based on the group delay (step S23). The shift amount output unit 184 outputs the shift amount (step S24).

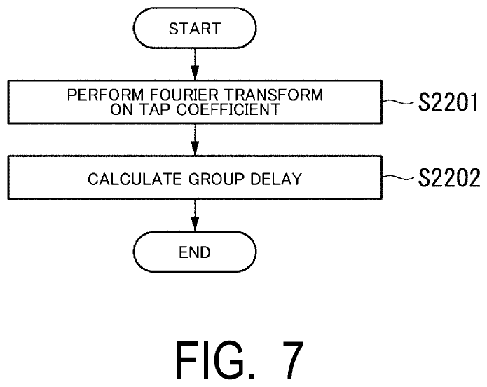

FIG. 7 is a flowchart illustrating a method for calculating a group delay. First, tap coefficients hₓₓ, h_{yx}, h_{xy}, and h_{yy} are subjected to discrete Fourier transform to calculate Hₓₓ, H_{yx}, H_{xy}, and H_{yy} (step S2201). Thereafter, the group delay is calculated using Equation (7) (step S2202).

As described above, the sample interval synchronized position notification device 18 can provide the sampling phase synchronization unit 14 with the synchronized position of the sample point interval. In a case where the sampling phase synchronization unit 14 performs synchronization only by the synchronized position at the symbol point interval, when the sampling phase is synchronized by the timing error detector 142 and the below-sample-interval shift units 143-1 and 143-2, it is likely that the influence of polarization mode dispersion cannot be compensated for depending on the time range that can be covered by the tap coefficients of the adaptive equalization unit 15. However, in the present embodiment, the sample interval synchronized position notification device 18 calculates the group delay τ(ω) based on the tap coefficient of the adaptive equalization unit 15, and calculates the shift amount Δτ based on the group delay τ(ω). The sample interval shift unit 141 of the sampling phase synchronization unit 14 synchronizes the interval between sample points for the X signal and the Y signal based on the shift amount Δτ, and thus the sampling phase can be synchronized by distinguishing whether a particular sample point is a symbol point or a transition point, and the influence of polarization mode dispersion can be compensated for.

### Second Calculation Method

Furthermore, if a range for estimating the group delay is allowed to be narrow, the group delay calculation unit 182 can also calculate the group delay using the following method. The group delay calculation unit 182 calculates Hₓₓ.

$$\begin{matrix}[ Math . 8 ] & \\ {H}_{x x} ( {ω}_{F s / 4} ) = {w}^{T} ( \frac{F s}{4} ) {h}_{x x} ( n ) = [ 1 , - i , - 1 , i , 1 , … ] {[ {h}_{xx} ( n ) , {h}_{xx} ( n + 1 ) , … , {h}_{x x} ( 2 n - 1 ) , 0 , … , 0 , {h}_{xx} ( 1 ) , {h}_{xx} ( 2 ) , … , {h}_{xx} ( n - 1 ) ]}^{T} & ( 8 )\end{matrix}$$

$$\begin{matrix}[ Math . 9 ] & \\ {H}_{x x} ( - {ω}_{F s / 4} ) = {w}^{T} ( - \frac{F s}{4} ) {h}_{x x} ( n ) = [ 1 , i , - 1 , - i , 1 , … ] {[ {h}_{xx} ( n ) , {h}_{xx} ( n + 1 ) , … , {h}_{x x} ( 2 n - 1 ) , 0 , … , 0 , {h}_{xx} ( 1 ) , {h}_{xx} ( 2 ) , … , {h}_{xx} ( n - 1 ) ]}^{T} & ( 9 )\end{matrix}$$

ω_{Fs/4} represents a frequency component that is one-fourth of a sampling rate Fs. w represents a rotator of the discrete Fourier transform matrix. If the tap length is not a power of 2, it is not possible to transform as shown on the right sides of Equations (8) and (9). Therefore, if the tap length is not a power of 2, by adding zero to the end of the tap coefficient, the sequence length after adding zero becomes a power of 2, and all rotators become integers, and the calculation on the right sides of Equations (8) and (9) becomes available. In the calculation on the right side of Equation (8), if m is an integer, hₓₓ(4 m) is multiplied by 1, hₓₓ(4 m+1) is multiplied by −i, hₓₓ(4 m+2) is multiplied by −1, hₓₓ(4 m+3) is multiplied by i, and the sum of the multiplied values is calculated. In the calculation on the right side of Equation (9), if m is an integer, hₓₓ(4 m) is multiplied by 1, hₓₓ(4 m+1) is multiplied by i, hₓₓ(4 m+2) is multiplied by −1, hₓₓ(4 m+3) is multiplied by −i, and the sum of the multiplied values is calculated. Therefore, in the calculations on the right sides of Equations (8) and (9), after calculating the sums of hₓₓ(4m), hₓₓ(4 m+1), hₓₓ(4 m+2), and hₓₓ(4 m+3), respectively, the respective sums may be multiplied by a predetermined number and then summed. In the calculations on the right sides of Equations (8) and (9), the only difference is the values by which hₓₓ(4 m+1) and hₓₓ(4 m+3) are multiplied, so the respective sums of hₓₓ(4 m), hₓₓ(4 m+1), hₓₓ(4 m+2), and hₓₓ(4 m+3) calculated in either Equation (8) or (9) may be used for calculation in the other equation.

The group delay calculation unit 182 may similarly calculate H_{yx}, H_{xy}, and H_{yy}.

Thereafter, the group delay calculation unit 182 calculates the group delay τ(ω) using Equation (10).

$$\begin{matrix}[ Math . 10 ] & \\ τ ( ω ) = - \frac{ϕ ( ω + δω ) - ϕ ( ω )}{δ ω} = - \frac{arg [ \{ {H}_{xx} ( {ω}_{F s / 4} ) {H}_{y y} ( {ω}_{F s / 4} ) - {H}_{y x} ( {ω}_{F s / 4} ) {H}_{x y} ( {ω}_{F s / 4} ) \} \{ {H}_{xx}^{*} ( - {ω}_{F s / 4} ) {H}_{y y}^{*} ( - {ω}_{F s / 4} ) - {H}_{y x}^{*} ( - {ω}_{F s / 4} ) {H}_{x y}^{*} ( - {ω}_{F s / 4} ) \} ]}{2 ( {ω}_{F s / 4} - ( - {ω}_{F s / 4} ) )} & ( 10 )\end{matrix}$$

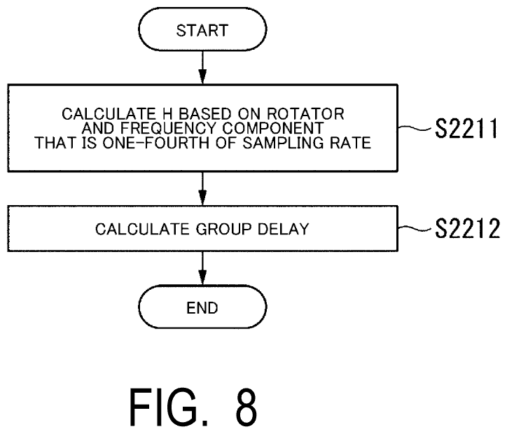

FIG. 8 is a flowchart illustrating a method for calculating a group delay. First, Hₓₓ, H_{yx}, H_{xy} and H_{yy} are calculated based on the tap coefficients hₓₓ, h_{yx}, h_{xy} and h_{yy}, the rotator, and the frequency component of one-fourth of the sampling rate (step S2211). Thereafter, the group delay is calculated using Equation (10) (step S2212).

### Method Using PMD Operator

Further, the group delay calculation unit 182 may calculate the group delay by calculating a Polarization Mode Dispersion (PMD) operator D(ω) shown in Equation (11).

$$\begin{matrix}[ Math . 11 ] & \\ D ( ω ) = j \frac{d H ( ω )}{d ω} {H ( ω )}^{- 1} & ( 11 )\end{matrix}$$

H(ω) represented a matrix calculated by Equation (2). The group delay calculation unit 182 calculates two eigenvalues of the PMD operator D(ω). The group delay calculation unit 182 calculates the sum of the two eigenvalues. The sum of the two eigenvalues is the polarization-independent group delay. A difference between the two eigenvalues is a difference in delay between the polarizations (differential group delay).

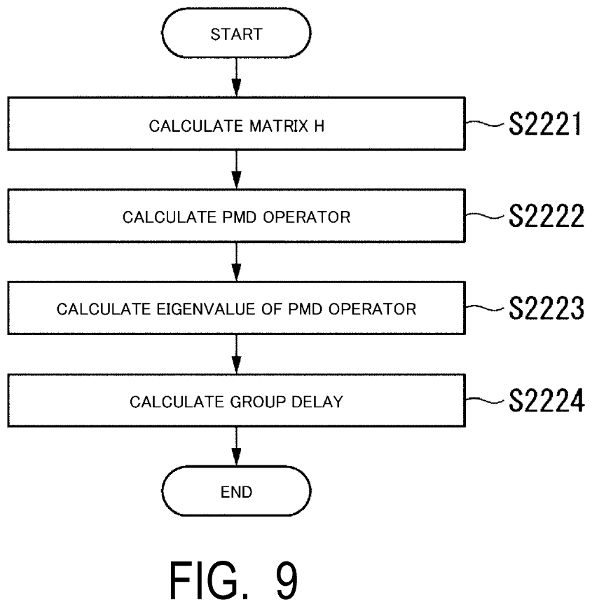

FIG. 9 is a flowchart illustrating a method for calculating a group delay. First, the tap coefficients hₓₓ, h_{yx}, h_{xy} and h_{yy} are subject to the discrete Fourier transform to calculate a matrix H having Hₓₓ, H_{yx}, H_{xy} and H_{yy} as elements (step S2221). Thereafter, the PMD operator D is calculated using Equation (11) (step S2222). The eigenvalue of the PMD operator D is calculated (step S2223). Thereafter, the sum of the two eigenvalues is calculated to calculate the group delay (step S2224).

### Other Embodiments

Although one embodiment of the present invention has been described in detail above with reference to the drawings, the specific configuration is not limited to such embodiment, and includes any design modifications and alterations without departing from the scope of the present invention.

### Reference Signs List

1 Optical receiver
11 Optical detection unit
12 ADC
13 Wavelength dispersion compensation unit
14 Sampling position synchronization unit
15 Adaptive equalization unit
16 Frame synchronization unit
17 Decoder unit
18 Sample interval synchronized position notification device
141 Sample interval shift unit
142 Timing error detector
143 Below-sample-interval shift unit
151 Filter
152 Multiplexer
153 Compensation unit
154 Tap update unit
181 Tap coefficient acquisition unit
182 Group delay calculation unit
183 Shift amount calculation unit
184 Shift amount output unit

1. A sample interval synchronized position notification device, comprising:
a tap coefficient acquirer unit configured to acquire a tap coefficient from an adaptive equalization unit which is configured to perform adaptive equalization of a signal;
a group delay calculator configured to calculate a group delay based on the tap coefficient; and
a shift amount calculator configured to calculate a shift amount based on the group delay.

2. The sample interval synchronized position notification device according to claim 1, wherein the group delay calculator s configured to:
perform a discrete Fourier transform on the tap coefficient; and
calculate the group delay using the discrete Fourier transform results.

3. The sample interval synchronized position notification device according to claim 1, wherein the group delay calculator is configured to:
calculate the group delay by calculation based on a rotator of a discrete Fourier transform matrix and a frequency component of one-fourth of a sampling rate.

4. The sample interval synchronized position notification device according to claim 1, wherein the group delay calculator is configured to:
perform a discrete Fourier transform on the tap coefficient and calculate a matrix whose elements are the discrete Fourier transform results;
calculate a PMD operator based on the matrix; and
calculate the group delay by calculating an eigenvalue of the PMD operator.

5. An optical receiver, comprising:
the sample interval synchronized position notification device according to claim 1;
an adaptive equalizer configured to adaptively equalize a signal based on the tap coefficient;
a sampling phase synchronizer configured to synchronize a sample position of the received signal at a sample period based on the shift amount.

6. A sample interval synchronized position notification method, comprising:
acquiring a tap coefficient from an adaptive equalization unit which is configured to perform adaptive equalization of a signal;
calculating a group delay based on the tap coefficient; and
calculating a shift amount based on the group delay.
